(19) United States
(12) Patent Application Publication
(10) Pub. No.: US 2021/0325132 A1
(43) Pub. Date: Oct. 21, 2021

(54) SHOCKWAVE SUPPLY DEVICE

(71) Applicant: MITSUBISHI HEAVY INDUSTRIES, LTD., Tokyo (JP)

(72) Inventors: Keisuke MATSUYAMA, Tokyo (JP); Kuninori TOGAI, Tokyo (JP); Shin ASANO, Tokyo (JP); Tomoaki INOUE, Tokyo (JP); Tomohito NAKAMORI, Tokyo (JP)

(21) Appl. No.: 17/213,742

(22) Filed: Mar. 26, 2021

(30) Foreign Application Priority Data
Apr. 20, 2020 (JP) 2020-074924

(51) Int. Cl. F28G 7/00; F27D 25/00

(52) U.S. Cl. CPC F28G 7/00; F27D 25/001

(57) ABSTRACT

A shockwave supply device includes: a shockwave generating unit configured to generate a shockwave; a shockwave emitting unit configured to emit the shockwave; a conduit that is bendable and is provided at a part of a flow path of the shockwave from the shockwave generating unit to the shockwave emitting unit; a plurality of outer shell tubes provided outward in a radial direction of the conduit and provided along an axial direction of the conduit; and a coupling portion with which adjacent ones of the outer shell tubes are coupled to be rotatable with respect to each other about a vertical axis.

### CROSS-REFERENCE TO RELATED APPLICATIONS

This application claims the benefit of priority to Japanese Patent Application Number 2020-074924 filed on Apr. 20, 2020. The entire contents of the above-identified application are hereby incorporated by reference.

### TECHNICAL FIELD

The disclosure relates to a shockwave supply device.

### RELATED ART

Methods of removing ash, dust, and the like adhered to an environmental plant device such as a furnace that uses coal, petroleum, waste or the like, a boiler, a gasification device, a heat exchanger, a heat recovery unit, or a reheater, using shockwaves are known (JP 2019-203607 A, for example).

### SUMMARY

The shockwaves rapidly attenuate after emission. Thus, the reachable range of the shockwaves from a known shockwave supply device fixed to a wall of a device is about 4 m, meaning that it is difficult to supply the shockwaves to the vicinity of the center of a huge furnace or the like with a size exceeding 10 m. A shockwave supply device fixed to the wall of a device is further plagued by a problem of increased costs because quite a few such devices may be required to be installed.

The present disclosure is made in view of the problem described above, and an object of the present disclosure is to provide a shockwave supply device capable of supplying shockwaves to a large scale device or plant.

A shockwave supply device according to the present disclosure includes: a shockwave generating unit configured to generate a shockwave; a shockwave emitting unit configured to emit the shockwave; a conduit that is bendable and is provided at a part of a flow path of the shockwave from the shockwave generating unit to the shockwave emitting unit; a plurality of outer shell tubes provided outward in a radial direction of the conduit and provided along an axial direction of the conduit; and a coupling portion with which adjacent ones of the outer shell tubes are coupled to be rotatable with respect to each other about a vertical axis.

With the shockwave supply device of the present disclosure, a part of the flow path for the shockwaves from the shockwave generating unit to the shockwave emitting unit is bendable, enabling movement along the axial direction of the conduit even in a limited space. Thus, even in a large scale device or plant, the shockwave emitting unit can be arranged around the center portion, whereby the shockwaves can be supplied to the center portion. Thus, the reachable range of the shockwaves can be increased, whereby a removal range of ash, dust, and the like is increased, contributing to a reduction in the number of installed devices.

### BRIEF DESCRIPTION OF DRAWINGS

The disclosure will be described with reference to the accompanying drawings, wherein like numbers reference like elements.

FIG. 1 is a plan view schematically illustrating an example of a shockwave supply device according to a first embodiment.

FIG. 2 is an end face view taken along line A-A in FIG. 1.

FIG. 3 is a rear view of a shockwave generating unit of the shockwave supply device illustrated in FIG. 1.

FIG. 4 is a plan view schematically illustrating an example of a shockwave supply device according to a second embodiment.

FIG. 5 is a partially enlarged side view of the shockwave supply device illustrated in FIG. 4.

Hereinafter, embodiments of a shockwave supply device according to the present disclosure will be described in detail with reference to the drawings. Note that the present disclosure is not in any way limited by the description of embodiments below. In addition, the components in the following embodiments include those that can be easily replaced by a person skilled in the art, those that are substantially the same, or those within an equivalent range. Further, it is possible to make various omissions, substitutions, and changes to the components described below within a range not departing from the scope of the disclosure. In the following embodiments, components necessary for describing exemplary embodiments of the shockwave supply device according to the present disclosure will be described, and other components will be omitted. In the description of the following embodiments, the same configurations are denoted by the same reference signs, and different configurations are denoted by different reference signs.

### FIRST EMBODIMENT

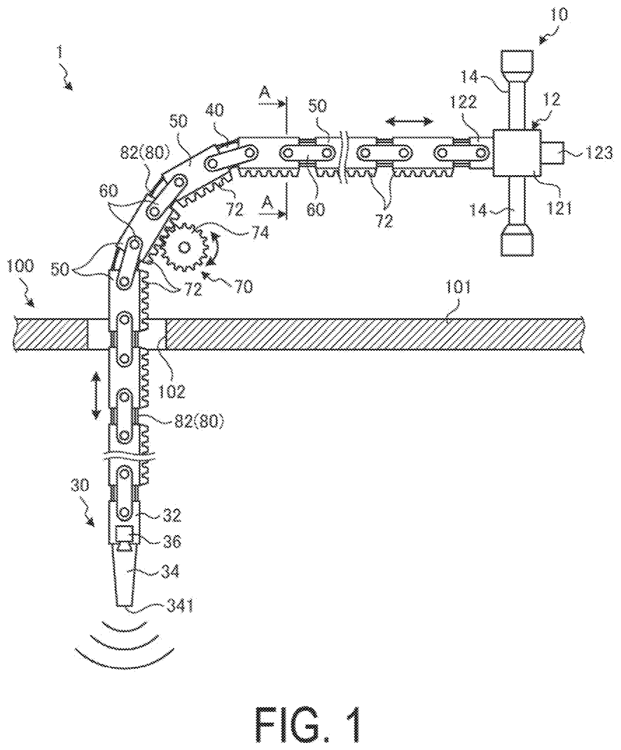

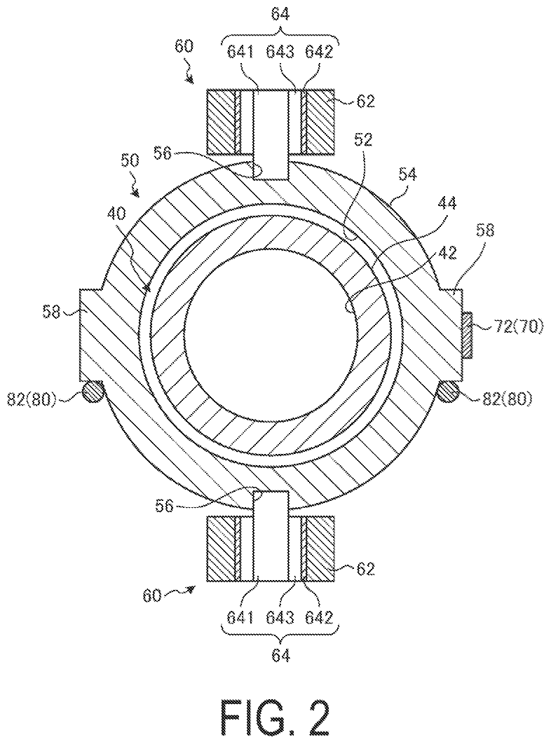

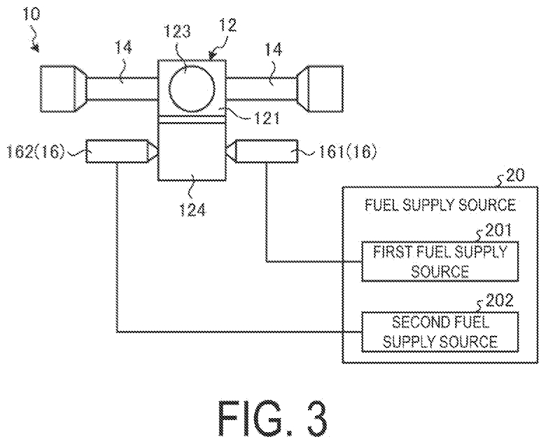

First, the configuration of a shockwave supply device 1 according to a first embodiment will be described. FIG. 1 is a plan view schematically illustrating an example of the shockwave supply device 1 according to the first embodiment. FIG. 2 is an end face view taken along line A-A in FIG. 1. FIG. 3 is a rear view of a shockwave generating unit 10 of the shockwave supply device 1 illustrated in FIG. 1.

The shockwave supply device 1 is a device that generates shockwaves and emits these shockwaves at a predetermined location to remove ash, dust, and the like adhered to various devices. For example, the various devices include an environmental plant device such as a furnace using coal, petroleum or waste, a boiler, a gasification device, a heat exchanger, a heat recovery unit, and a reheater. Shockwaves are pressure waves, such as sound waves, that propagate faster than the speed of sound. Shockwaves are generated, for example, by explosion of explosives, steam, or the like, high pressure release, and the like.

As illustrated in FIG. 1, the shockwave supply device 1 according to the first embodiment includes the shockwave generating unit 10, a fuel supply source 20, a shockwave emitting unit 30, a conduit 40, outer shell tubes 50, coupling portions 60, a position adjustment mechanism 70, and an emission direction adjustment mechanism 80. Note that in the following description, the side of the fuel supply source 20, which is a supply source of fuel for generating shockwaves, is referred to as upstream, and the side of the shockwave emitting unit 30 from which the shockwaves are emitted is referred to as downstream. The upstream side and the downstream side of each portion are respectively referred to as a back or rear surface side and a forward or front surface side.

The shockwave generating unit 10 generates shockwaves. In the first embodiment, the shockwave generating unit 10 sends the generated shockwaves to the conduit 40. The shockwave generating unit 10 is installed outside a device main body 100 of a device including a heat exchanger or the like. In the first embodiment, the shockwave generating unit 10 includes a main body portion 12, combustion chambers 14, and fuel storage units 16.

In the first embodiment, the main body portion 12 includes a housing 121, a connecting tube 122, a cylinder 123, and a valve unit 124. The housing 121 is in communication with the connecting tube 122, the cylinder 123, the combustion chambers 14, and the fuel storage units 16.

The connecting tube 122 is provided on the front surface side of the housing 121. The axial direction of the connecting tube 122 is parallel with the front-back direction of the shockwave generating unit 10. The connecting tube 122 has an upstream side end portion in communication with the housing 121. The connecting tube 122 has a downstream side end portion in communication with the conduit 40.

The cylinder 123 is provided on the rear surface side of the housing 121 that is opposite to the side on which the connecting tube 122 is provided. The axial direction of the cylinder 123 is parallel with the front-back direction of the shockwave generating unit 10. The housing 121 and the cylinder 123 incorporate a piston that is movable in the front-back direction along the cylinder 123.

The valve unit 124 is provided in a lower portion of the housing 121. The valve unit 124 is connected to the fuel storage units 16. The valve unit 124 causes the interior of the fuel storage units 16 to be isolated from the combustion chambers 14, or to communicate with the combustion chambers 14.

The combustion chambers 14 are provided as a pair extending laterally from both side surfaces of the housing 121. Movement of the piston in the housing 121 along the cylinder 123 causes the combustion chambers 14 to be isolated from or communicate with the interior of the connecting tube 122. The combustion chambers 14 are isolated from or communicate with the interior of the fuel storage units 16 by the valve unit 124. The combustion chambers 14 communicate with the connecting tube 122 after combusting the fuel received from the fuel storage units 16, so that a shockwave is generated.

The fuel storage units 16 store fuel to be supplied to the combustion chambers 14. In the first embodiment, the fuel storage units 16 include a first fuel storage unit 161 and a second fuel storage unit 162. The first fuel storage unit 161 is provided below the combustion chamber 14 and extends laterally from one side surface of the housing 121. The first fuel storage unit 161 stores a first fuel. In the first embodiment, the first fuel includes fuel gas such as methane. The second fuel storage unit 162 is provided below the combustion chamber 14 and extends laterally from the other side surface of the housing 121. The second fuel storage unit 162 stores a second fuel. In the first embodiment, the second fuel includes oxygen. The valve unit 124 causes the first fuel storage unit 161 and the second fuel storage unit 162 to be isolated from or to communicate with the combustion chambers 14.

In the first embodiment, the fuel supply source 20 is connected to the fuel storage units 16 of the shockwave generating unit 10. In the first embodiment, the fuel supply source 20 includes a first fuel supply source 201 and a second fuel supply source 202. The first fuel supply source 201 supplies the first fuel to the first fuel storage unit 161. The second fuel supply source 202 supplies the second fuel to the second fuel storage unit 162.

In the shockwave generating unit 10, when the first fuel storage unit 161 and the second fuel storage unit 162 communicate with the pair of combustion chambers 14, fuel gas is supplied from the first fuel storage unit 161 to one of the combustion chambers 14 and air is supplied from the second fuel storage unit 162 to the other combustion chamber 14. The fuel gas and oxygen are mixed inside the combustion chambers 14 after the first fuel storage unit 161 and the second fuel storage unit 162 are isolated from the pair of combustion chambers 14. In the shockwave generating unit 10, a shockwave is generated when the fuel-air mixture inside the combustion chambers 14 is ignited to be combusted and the piston in the housing 121 establishes communication between the interior of the combustion chambers 14 and the connecting tube 122. In the first embodiment, the shockwave propagates into the conduit 40 through the connecting tube 122.

The shockwave emitting unit 30 emits the shockwave generated by the shockwave generating unit 10. In the first embodiment, the shockwave emitting unit 30 emits the shockwave propagating through the conduit 40. The shockwave emitting unit 30 is installed inside the device main body 100 of the device including a heat exchanger or the like. The shockwave emitting unit 30 includes a connecting tube 32, a nozzle 34, and an image capturing unit 36 in the first embodiment.

The connecting tube 32 has an upstream side end portion in communication with the conduit 40 in the first embodiment. The connecting tube 32 has a downstream side end portion in communication with the nozzle 34.

The nozzle 34 has a tip end provided with an emission port 341 through which a shockwave is emitted. The interior of the nozzle 34 communicates with the interior of the conduit 40 through the connecting tube 32. The shockwave propagating from the conduit 40 through the connecting tube 32 is emitted into the internal space of the device main body 100 through the emission port 341 of the nozzle 34. In the first embodiment, the shockwave flow path in the nozzle 34 has a linear axis and is tapered toward the emission port 341. However, the shape of the nozzle 34 is not limited to that in the first embodiment.

The image capturing unit 36 captures an image on the front side of the shockwave emitting unit 30, that is, in a direction of orientation of the emission port 341, through which the shockwave is emitted. The image capturing unit 36 captures an image of ash and dust adhered to various components in the device main body 100, for example. The captured image acquired by the image capturing unit 36 is acquired by, for example, a control device provided outside the device main body 100. The captured image is displayed, for example, on a display unit of the control device in real-time. In the first embodiment, the image capturing unit 36 is attached to an upper surface of the connecting tube 32, but may be attached to the nozzle 34.

The conduit 40 is a flexible tube that is bendable. The conduit 40 has corrosion resistance and heat resistance. The conduit 40 is provided in a part of the flow path from the fuel supply source 20 of the fuel supplied to the shockwave generating unit 10 to the shockwave emitting unit 30. The flow path is a flow path of the shockwave, or is a flow path of a fluid such as the fuel for generating the shockwave. Examples of the fuel include fuel gas or high pressure gas for combustion. The shockwave or fuel passes through a space further inward than an inner peripheral surface 42 of the conduit 40. Thus, the conduit 40 is sealed between the connecting tube 122 of the shockwave generating unit 10 and the connecting tube 32 of the shockwave emitting unit 30. The outer shell tubes 50 are provided on the side of an outer peripheral surface 44 of the conduit 40.

In the first embodiment, the conduit 40 is provided between the shockwave generating unit 10 and the shockwave emitting unit 30. In the first embodiment, the conduit 40 passes through a hole 102 in a wall 101 of the device main body 100, and connects the shockwave generating unit 10 provided outside the device main body 100 and the shockwave emitting unit 30 provided inside the device main body 100 to each other. The conduit 40 has an upstream side end portion in communication with the connecting tube 122 of the shockwave generating unit 10. The conduit 40 has a downstream side end portion in communication with the connecting tube 32 of the shockwave emitting unit 30. Thus, the conduit 40 connects the connecting tube 122 of the shockwave generating unit 10 and the connecting tube 32 of the shockwave emitting unit 30 to each other. In the first embodiment, the shockwaves generated by the shockwave generating unit 10 propagate to the shockwave emitting unit 30 through the conduit 40. Note that, in the following description, the side of the shockwave emitting unit 30 and the side of the shockwave generating unit 10 opposite thereto in the axial direction of the conduit 40 are respectively referred to as a front side and a rear side.

The outer shell tubes 50 are provided outward in the radial direction of the conduit 40. The outer shell tube 50 has an inner peripheral surface 52 facing the outer peripheral surface 44 of the conduit 40 while being separated therefrom. A plurality of the outer shell tubes 50 are provided along the axial direction of the conduit 40. One outer shell tube 50 is connected to another adjacent outer shell tube 50 via a coupling portion 60. More specifically, with the coupling portion 60, one outer shell tube 50 is coupled to another adjacent outer shell tube 50 to be rotatable with respect thereto about a vertical axis.

In the first embodiment, the outer shell tubes 50 each include an outer peripheral surface 54 formed with holes 56 provided as recesses in a vertical direction in an upper portion and a lower portion. One outer shell tube 50 is formed with a total of four holes 56, that is, two in the axial direction on each of the upper portion and the lower portion. An inner shaft 641 of a later described bearing 64 of the coupling portion 60 is inserted and fixed in each of the holes 56.

In the first embodiment, the outer shell tubes 50 each include a pair of wire holding portions 58 provided to protrude on both side portions of the outer peripheral surface 54. With the wire holding portions 58, wires 82 of the emission direction adjustment mechanism 80 described later are held while being movable in a direction parallel to the axial direction. One of the wire holding portions 58 is provided with a rack 72 of the position adjustment mechanism 70 described later, along the direction parallel to the axial direction.

The coupling portion 60 couples adjacent outer shell tubes 50 in a rotatable manner with respect to each other about the vertical axis. In the first embodiment, the coupling portion 60 includes a main body 62 and the bearing 64. In the first embodiment, the main body 62 has a plate shape with one end coupled to one outer shell tube 50 and the other end coupled to another outer shell tube 50. The main body 62 is provided so as to be rotatable about the vertical axis with respect to the outer shell tube 50 via the bearing 64. A pair of the main bodies 62 is provided above the outer shell tube 50 and another pair of the main bodies 62 is provided below the outer shell tube 50, with the adjacent outer shell tubes 50 provided therebetween. The main bodies 62 each include a hole formed in the vertical direction for fixing an outer ring 642 of the bearing 64.

In the first embodiment, the bearing 64 is a cam follower including the inner shaft 641, the outer ring 642, and a plurality of needle-shaped rollers 643 provided between the inner shaft 641 and the outer ring 642. The inner shaft 641 is inserted and fixed into a hole formed in the outer peripheral surface 54 of the outer shell tube 50. The outer ring 642 is fixed to the inner side of a hole formed in the main body 62. As a result, the outer shell tube 50 and one end of the coupling portion 60 are coupled to be rotatable with respect to each other about the vertical axis. With the outer shell tubes 50 coupled in series by the coupling portions 60, the conduit 40 is bendable only in the horizontal direction and is restricted from bending in the vertical direction.

At a portion where the upstream side end portion of the conduit 40 is connected to the connecting tube 122 of the shockwave generating unit 10, the outer shell tube 50 and the connecting tube 122 are coupled to be rotatable with respect to each other about the vertical axis by the coupling portion 60. Specifically, the connecting tube 122 includes holes in which the inner shafts 641 are inserted and fixed, as in the outer shell tubes 50. At a portion where the downstream side end portion of the conduit 40 is connected to the connecting tube 32 of the shockwave emitting unit 30, the outer shell tube 50 and the connecting tube 32 are coupled to be rotatable with respect to each other about the vertical axis by the coupling portion 60. Specifically, the connecting tube 32 includes holes in which the inner shafts 641 are inserted and fixed, as in the outer shell tubes 50.

The shockwave supply device 1 includes the conduit 40 that is bendable in the horizontal direction, and thus the section from the shockwave generating unit 10 to the shockwave emitting unit 30 need not be linearly arranged. Specifically, as illustrated in FIG. 1, the conduit 40 on the side of the shockwave emitting unit 30 is orthogonally inserted into the hole 102 formed in the wall 101 of the device main body 100 in plan view. As a result, the emission port 341 of the shockwave emitting unit 30 is disposed so as to be oriented toward the inner side (lower side in FIG. 1) of the device main body 100. At the same time, the conduit 40 on the side of the shockwave generating unit 10 may be disposed along the wall 101 of the device main body 100 as illustrated in FIG. 1. The shockwave supply device 1 includes a sealing mechanism that provides sealing in the hole 102. The sealing mechanism may provide sealing between the portion of the shockwave supply device 1 inserted into the hole 102 and the wall 101 of the device main body 100, or may be an elastic structure having a size changing in accordance with the movement of the shockwave supply device 1 while covering the entirety of the shockwave supply device 1.

In the first embodiment, a bent portion of the conduit 40 is preferably provided with a guide member or the like that restricts the movement of the conduit 40 in a direction other than the axial direction. The guide may include, for example, a guide rail provided along the axial direction of the conduit 40 at a portion where the conduit 40 outside the device main body 100 bends, and a guided portion provided on the outer shell tubes 50 while being slidable along the guide rail. With this configuration, the shockwave supply device 1 can move in the axial direction of the conduit 40 while having the conduit 40 deformed, that is, with the bent position changed. For example, in FIG. 1, leftward movement of the shockwave generating unit 10 causes downward movement of the shockwave emitting unit 30.

The position adjustment mechanism 70 causes the shockwave generating unit 10, the shockwave emitting unit 30, and the conduit 40 to move forward and rearward along the axial direction of the conduit 40. In the first embodiment, the position adjustment mechanism 70 includes the racks 72 and a pinion 74.

The racks 72 are provided to one of the wire holding portions 58 of the respective outer shell tubes 50. More specifically, the racks 72 are provided to the wire holding portion 58 on the side where the conduit 40 bends in a recessed manner. The racks 72 are provided along the direction parallel to the axial direction of the outer shell tubes 50. In the first embodiment, the racks 72 are provided over the respective outer shell tubes 50 along the axial direction. In a linear portion of the conduit 40, the adjacent racks 72 are spaced apart from one another. In the portion where the conduit 40 is bent, the adjacent racks 72 are proximate to each other.

The pinion 74 is fixedly provided at a predetermined position outside the device main body 100. The pinion 74 is rotatable about the vertical axis. The pinion 74 is provided to mesh with the rack 72 at the portion where the conduit 40 is bent. The pinion 74 is rotated, for example, by rotational driving force from a driving source. The driving source for the pinion 74 may be controlled by a control device or the like that controls the components of the shockwave supply device 1. Rotation of the pinion 74 causes the outer shell tubes 50 to move in the axial direction via the racks 72. The movement of the outer shell tubes 50 in the axial direction results in the shockwave generating unit 10, the shockwave emitting unit 30, and the conduit 40 moving forward and rearward along the axial direction of the conduit 40, with the bent position of the conduit 40 changed.

The emission direction adjustment mechanism 80 adjusts the direction of orientation of the emission port 341 of the nozzle 34 of the shockwave emitting unit 30. In the first embodiment, the emission direction adjustment mechanism 80 includes a pair of the wires 82.

The wires 82 are provided along a direction substantially parallel with the axial direction of the conduit 40. The wires 82 are provided substantially symmetrical with respect to the axial center in plan view. In the first embodiment, the wires 82 are held by the wire holding portions 58 while being movable in the direction substantially parallel with the axial direction. The wires 82 have downstream side end portions fixed to the shockwave emitting unit 30. The wires 82 have upstream side end portions fixed to a winding device or the like provided on the side of the shockwave generating unit 10. The lengths of the side edges of the pair of wires 82 in parallel with the axial direction of the conduit 40 are individually adjustable. Specifically, when one of the pair of wires 82 is wound from the side of the shockwave generating unit 10, the portion of the wire 82 between the shockwave generating unit 10 and the shockwave emitting unit 30 becomes shorter. Thus, when the nozzle 34 is pulled by the wire 82 to be rotated about the vertical axis, the direction of the orientation of the emission port 341 changes.

An operator may drive the emission direction adjustment mechanism 80 based on the captured image acquired from the image capturing unit 36 of the shockwave emitting unit 30. Thus, the direction of orientation of the emission port 341 of the nozzle 34 may be adjusted in accordance with the positions of ash, dust, and the like inside the device main body 100.

### SECOND EMBODIMENT

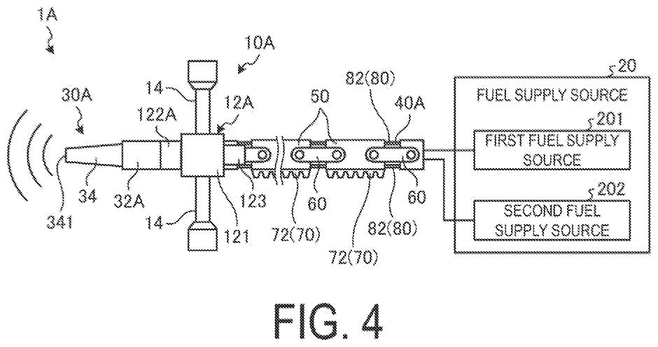

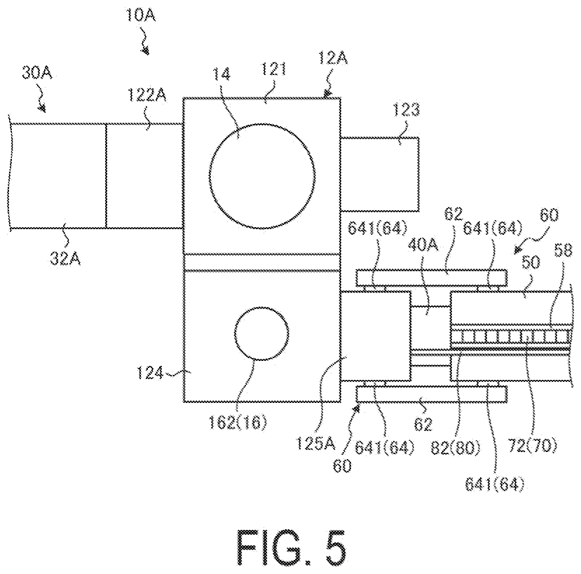

Next, the configuration of a shockwave supply device 1A according to a second embodiment will be described. FIG. 4 is a plan view schematically illustrating an example of the shockwave supply device 1A according to the second embodiment. FIG. 5 is a partially enlarged side view of the shockwave supply device 1A illustrated in FIG. 4. Parts of FIGS. 4 and 5 that are the same as counterparts in the first embodiment will be denoted with the same reference signs, and a description thereof will be omitted. The shockwave supply device 1A according to the second embodiment includes a shockwave generating unit 10A, the fuel supply source 20, a shockwave emitting unit 30A, a conduit 40A, the outer shell tubes 50, the coupling portions 60, the position adjustment mechanism 70, and the emission direction adjustment mechanism 80.

The shockwave generating unit 10A according to the second embodiment differs from the shockwave generating unit 10 according to the first embodiment in that the generated shockwaves propagate directly to the shockwave emitting unit 30A without passing through the conduit 40A. Furthermore, the shockwave generating unit 10A differs from the shockwave generating unit 10 according to the first embodiment in that the fuel used for generating the shockwaves is received via the conduit 40A. The shockwave generating unit 10A includes a main body portion 12A, the combustion chambers 14, and the fuel storage units 16. The basic configurations and functions of the combustion chambers 14 and the fuel storage units 16 are the same as those in the first embodiment, and thus a description thereof will be omitted.

The main body portion 12A includes the housing 121, a connecting tube 122A, the cylinder 123, the valve unit 124, and a connecting tube 125A. The basic configurations and functions of the housing 121, the cylinder 123, and the valve unit 124 are the same as those in the first embodiment, and thus a description thereof will be omitted.

The connecting tube 122A is provided on the front surface side of the housing 121. The axial direction of the connecting tube 122A is parallel with the front-back direction of the shockwave generating unit 10A. The connecting tube 122A has an upstream side end portion in communication with the housing 121. The connecting tube 122A has a downstream side end portion in communication with a connecting tube 32A of the shockwave emitting unit 30A.

The connecting tube 125A is provided on the rear side of the valve unit 124. The connecting tube 125A has an upstream side end portion in communication with the conduit 40A. The connecting tube 125A has a downstream side end portion in communication with the fuel storage units 16. Note that, while each of the conduit 40A and the connecting tube 125A is illustrated as a single member in FIGS. 4 and 5, in the second embodiment, the first fuel is supplied to the first fuel storage unit 161 and the second fuel is supplied to the second fuel storage unit 162. Accordingly, in the second embodiment, the conduit 40A and the connecting tube 125A for supplying the first fuel to the first fuel storage unit 161 and the conduit 40A and the connecting tube 125A for supplying the second fuel to the second fuel storage unit 162 are provided while being separated from each other.

The shockwave emitting unit 30A according to the second embodiment differs from the shockwave emitting unit 30 according to the first embodiment in that the shockwaves generated by the shockwave generating unit 10A propagate directly thereto without passing through the conduit 40A. In the second embodiment, the shockwave emitting unit 30A includes a connecting tube 32A, and the nozzle 34. In the second embodiment, the connecting tube 32A has an upstream side end portion in communication with the connecting tube 122A of the shockwave generating unit 10A. The connecting tube 32A has a downstream side end portion in communication with the nozzle 34.

The interior of the nozzle 34 communicates with the interior of the connecting tube 122A of the shockwave generating unit 10A through the connecting tube 32A. The basic configuration and function of the nozzle 34 are the same as those in the first embodiment, and thus a description thereof will be omitted. The shockwave emitting unit 30A may include the image capturing unit 36 as in the first embodiment.

The conduit 40A according to the second embodiment differs from the conduit 40 according to the first embodiment in that the conduit 40A is provided between the shockwave generating unit 10A and the fuel supply source 20. In the second embodiment, the conduit 40A passes through the hole 102 (see FIG. 1) in the wall 101 of the device main body 100, and connects the fuel supply source 20 provided outside the device main body 100 (see FIG. 1) and the shockwave generating unit 10A provided inside the device main body 100 to each other. The conduit 40A has an upstream side end portion in communication with the fuel supply source 20. The conduit 40A has a downstream side end portion in communication with the connecting tube 125A of the shockwave generating unit 10A. Thus, the conduit 40A connects the fuel supply source 20 and the connecting tube 125A of the shockwave generating unit 10A to each other. In the second embodiment, the conduit 40A sends the fuel used for generating a shockwave from the fuel supply source 20 to the shockwave generating unit 10A.

In the second embodiment, the conduit 40A includes a plurality of conduits 40A for sending different types of fuel. Specifically, the conduit 40A includes two conduits that are a conduit 40A for sending the first fuel and a conduit 40A for sending the second fuel arranged side by side. The two conduits 40A are provided side-by-side in an up-down direction, for example. The two conduits 40A are both disposed inwards in the radial direction of the outer shell tubes 50. The conduit 40A for sending the first fuel has an upstream side end portion in communication with the first fuel supply source 201. The conduit 40A for sending the first fuel has a downstream side end portion in communication with the first fuel storage unit 161 through the connecting tube 125A. The conduit 40A for sending the second fuel has an upstream side end portion in communication with the second fuel supply source 202. The conduit 40A for sending the second fuel has a downstream side end portion in communication with the second fuel storage unit 162 through the connecting tube 125A.

At a portion where the upstream side end portion of the conduit 40A is connected to the fuel supply source 20, the outer shell tube 50 and a casing of the fuel supply source 20 are coupled to be rotatable with respect to each other about the vertical axis by the coupling portion 60 according to the second embodiment. Specifically, the casing of the fuel supply source 20 includes holes in which the inner shafts 641 are inserted and fixed, as in the outer shell tubes 50. At a portion where the downstream side end portion of the conduit 40A is connected to the connecting tube 125A of the shockwave generating unit 10A, the outer shell tube 50 and the connecting tube 125A are coupled to be rotatable with respect to each other about the vertical axis by the coupling portion 60 according to the second embodiment. Specifically, the connecting tube 125A includes holes in which the inner shafts 641 are inserted and fixed, as in the outer shell tubes 50.

Further, in the emission direction adjustment mechanism 80 according to the second embodiment, the downstream end portions of the wires 82 are fixed to the shockwave generating unit 10A. The wires 82 have the upstream side end portions fixed to a winding device or the like provided on the side of the fuel supply source 20. Thus, the emission direction adjustment mechanism 80 according to the second embodiment changes the direction of orientation of the emission port 341 by making the shockwave emitting unit 30A rotate about the vertical axis integrally with the shockwave generating unit 10A.

### Actions and Effects of Each Embodiment

The shockwave supply device 1, 1A according to each embodiment is construed, for example, in the following manner.

The shockwave supply device 1, 1A according to a first aspect includes: the shockwave generating unit 10, 10A configured to generate a shockwave; the shockwave emitting unit 30, 30A configured to emit the shockwave; the conduit 40, 40A that is bendable and is provided at a part of a flow path of fuel or the shockwave from the fuel supply source 20 of the fuel supplied to the shockwave generating unit 10, 10A to the shockwave emitting unit 30, 30A; the plurality of outer shell tubes 50 provided outward in the radial direction of the conduit 40, 40A and provided along the axial direction of the conduit 40, 40A; and the coupling portion 60 with which adjacent ones of the outer shell tubes 50 are coupled to be rotatable with respect to each other about the vertical axis.

With the shockwave supply device 1 according to the first aspect, a part of the flow path for the shockwave from the shockwave generating unit 10 to the shockwave emitting unit 30 is bendable, enabling movement along the axial direction of the conduit 40 even in a limited space. Thus, even in a large scale device or plant, the shockwave emitting unit 30 can be arranged around the center portion, whereby shockwaves can be supplied to the center portion. Thus, the reachable range of the shockwave can be increased and the removal range of ash, dust, and the like is increased, and this contributes to a reduction in the number of installed devices. Furthermore, the shockwave generating unit 10 can be arranged outside a plant, while the shockwave emitting unit 30 is arranged in a center portion of the device or plant. With this configuration, the shockwave can be supplied to the center portion even when a gap between the devices is small.

In the shockwave supply device 1A according to a second aspect, a part of the flow path of fuel from the fuel supply source 20 to the shockwave generating unit 10A connected to the shockwave emitting unit 30A is bendable, enabling movement along the axial direction of the conduit 40A even in a limited space. Thus, even in a large scale device or plant, the shockwave emitting unit 30 can be arranged around the center portion, whereby the shockwave can be supplied to the center portion. Thus, the reachable range of the shockwave can be increased and the removal range of ash, dust, and the like is increased. This configuration contributes to a reduction in the number of installed devices. The flow path from the shockwave generating unit 10A to the shockwave emitting unit 30 can be made short, while the shockwave emitting unit 30 is arranged in a center portion of the device or the plant. With this configuration, the shockwave can be supplied to the center portion, and attenuation of the shockwave before being emitted can be suppressed.

In the shockwave supply device 1, 1 A according to a third aspect, the outer shell tubes 50 each have the inner peripheral surface 52 provided to face and to be separated from the outer peripheral surface 44 of the conduit 40, 40A. With this configuration, inhibition of the bending deformation of the conduit 40, 40A can be suppressed, whereby the movement along the axial direction of the bent conduit 40, 40A can be easily implemented.

The shockwave supply device 1, 1A according to a fourth aspect includes the position adjustment mechanism 70 that moves the shockwave generating unit 10, 10A, the shockwave emitting unit 30, 30A, and the outer shell tubes 50 in the axial direction of the conduit 40, 40A. With this configuration, the movement along the axial direction of the bent conduit 40, 40A can be easily implemented, and thus the position to which the shockwave is emitted can be easily adjusted.

In the shockwave supply device 1, 1A according to a fifth aspect, the position adjustment mechanism 70 includes the racks 72 that are provided to the outer shell tubes 50 along the axial direction, and the pinion 74 that is rotatable about the vertical axis while meshing with the racks 72. Thus, with a simple configuration, movement along the axial direction of the bent conduit 40, 40A is easily implemented, and thus the position to which the shockwave is emitted can be easily adjusted.

The shockwave supply device 1, 1A according to a sixth aspect includes the emission direction adjustment mechanism 80 configured to adjust the direction of orientation of the emission port 341 through which the shockwave is emitted from the shockwave emitting unit 30, 30A. Thus, the emission direction of the shockwave can be easily adjusted, whereby ash, dust, and the like can be more efficiently removed.

In the shockwave supply device 1, 1A according to a seventh aspect, the emission direction adjustment mechanism 80 is capable of adjusting a length of a side edge in parallel with the axial direction of the conduit 40, 40A in plan view. Thus, the emission direction of the shockwave can be easily adjusted, whereby ash, dust, and the like can be more efficiently removed.

In the shockwave supply device 1, 1A according to an eighth aspect, the shockwave emitting unit 30, 30A includes the image capturing unit 36 configured to capture an image in the direction of orientation of the emission port 341 through which the shockwave is emitted. With this configuration, an operator can recognize the position where ash, dust, or the like has adhered, and thus can more efficiently remove the ash, dust, or the like by, for example, adjusting the position and direction to/in which the shockwave is emitted based on the captured image.

The embodiments of the present disclosure are described above, but the embodiments are not limited by the content of the description of the embodiments above. For example, the position adjustment mechanism 70 is not limited to that in the embodiments. Furthermore, the shockwave supply device 1, 1A may not include the position adjustment mechanism 70. Thus, movement of the shockwave supply device 1, 1A may be implemented by an external device or may involve manpower.

Furthermore, the pinion 74, which is provided as a single component in the first embodiment, may be provided as a plurality of components to prevent idling in a portion between the adjacent racks 72. Furthermore, the pinion 74 may be provided in a portion where the conduit 40 is linear, and on a side where the conduit 40 is bent in a protruding manner. In this case, the racks 72 are provided on the wire holding portion 58 on the side where the conduit 40 bends in a protruding manner. The adjacent racks 72 are preferably provided to be longer than the length of the outer shell tubes 50 in the axial direction so that the teeth of the adjacent racks 72 can be continuous in the linear portion of the conduit 40.

While the shockwave generating unit 10 of the shockwave supply device 1 generates a shockwave by using the fuel supplied from the fuel supply source 20, the shockwave may be generated without using the fuel in the present disclosure. In such a case, the shockwave generating unit may generate a shockwave by releasing a high pressure fluid, for example.

While preferred embodiments of the invention have been described as above, it is to be understood that variations and modifications will be apparent to those skilled in the art without departing from the scope and spirit of the invention. The scope of the invention, therefore, is to be determined solely by the following claims.

1. A shockwave supply device comprising:
a shockwave generating unit configured to generate a shockwave;
a shockwave emitting unit configured to emit the shockwave;
a conduit that is bendable and is provided at a part of a flow path of the shockwave from the shockwave generating unit to the shockwave emitting unit;
a plurality of outer shell tubes provided outward in a radial direction of the conduit and provided along an axial direction of the conduit; and
a coupling portion with which adjacent ones of the outer shell tubes are coupled to be rotatable with respect to each other about a vertical axis.

2. A shockwave supply device comprising:
a shockwave generating unit configured to generate a shockwave;
a shockwave emitting unit that is connected to the shockwave generating unit and is configured to emit the shockwave;
a conduit that is bendable and is provided in a part of a flow path of fuel from a fuel supply source of the fuel supplied to the shockwave generating unit to the shockwave generating unit;
a plurality of outer shell tubes provided outward in a radial direction of the conduit and provided along an axial direction of the conduit; and
a coupling portion with which adjacent ones of the outer shell tubes are coupled to be rotatable with respect to each other about a vertical axis.

3. The shockwave supply device according to claim 1, wherein the outer shell tubes each have an inner peripheral surface provided to face and to be separated from an outer peripheral surface of the conduit.

4. The shockwave supply device according to claim 2, wherein the outer shell tubes each have an inner peripheral surface provided to face and to be separated from an outer peripheral surface of the conduit.

5. The shockwave supply device according to claim 1, further comprising a position adjustment mechanism that moves the shockwave generating unit, the shockwave emitting unit, and the outer shell tubes in the axial direction of the conduit.

6. The shockwave supply device according to claim 2, further comprising a position adjustment mechanism that moves the shockwave generating unit, the shockwave emitting unit, and the outer shell tubes in the axial direction of the conduit.

7. The shockwave supply device according to claim 5, wherein the position adjustment mechanism includes racks provided to the outer shell tubes along the axial direction, and a pinion that is rotatable about the vertical axis while meshing with the racks.

8. The shockwave supply device according to claim 6, wherein the position adjustment mechanism includes racks provided to the outer shell tubes along the axial direction, and a pinion that is rotatable about the vertical axis while meshing with the racks.

9. The shockwave supply device according to claim 1, further comprising an emission direction adjustment mechanism configured to adjust a direction of orientation of an emission port through which the shockwave is emitted from the shockwave emitting unit.

10. The shockwave supply device according to claim 2, further comprising an emission direction adjustment mechanism configured to adjust a direction of orientation of an emission port through which the shockwave is emitted from the shockwave emitting unit.

11. The shockwave supply device according to claim 9, wherein the emission direction adjustment mechanism is capable of adjusting a length of a side edge in parallel with the axial direction of the conduit in plan view.

12. The shockwave supply device according to claim 10, wherein the emission direction adjustment mechanism is capable of adjusting a length of a side edge in parallel with the axial direction of the conduit in plan view.

13. The shockwave supply device according to claim 1, wherein the shockwave emitting unit includes an image capturing unit configured to capture an image in a direction of orientation of the emission port through which the shockwave is emitted.

14. The shockwave supply device according to claim 2, wherein the shockwave emitting unit includes an image capturing unit configured to capture an image in a direction of orientation of the emission port through which the shockwave is emitted.
